(19) United States
(12) Patent Application Publication
(10) Pub. No.: US 2012/0137549 A1
(43) Pub. Date: Jun. 7, 2012

(54) Mailable one piece memorial marker

(76) Inventor: Jacob A. Caszatt, Sharpsville, PA (US)

(21) Appl. No.: 13/373,898

(22) Filed: Dec. 5, 2011

Related U.S. Application Data
(60) Provisional application No. 61/459,026, filed on Dec. 6, 2010.

(51) Int. Cl. G09F 19/00

(52) U.S. Cl. 40/124.5

(57) ABSTRACT

A one piece memorial marker that can be mailed in a card and/or envelope using standard letter postage. A two sided display that can depict a picture, poem, quote or saying on one side and have a blank or semi blank reverse side so a personnel message can be added by the sender or user. Utilizing the shape and rigidity of the marker itself it can be displayed at a grave or memorial site by pushing or rocking it into the ground or dirt by a person without the need of tools or additional foundational support.

### CROSS REFERENCE TO RELATED APPLICATIONS

61/459,026 U.S. Provisional Patent Application, Filed Dec. 6, 2010.

### STATEMENT REGARDING FEDERALLY SPONSORED RESEARCH AND DEVELOPMENT

Not applicable

### NAMES OF THE PARTIES TO A JOINT RESEARCH AGREEMENT

Not applicable

### REFERENCE TO A SEQUENCE LISTING

Not applicable

### BACKGROUND OF THE INVENTION

This invention is aimed at providing a means to have a personnel message displayed at a grave or memorial site.

There are numerous prior art devises that provide a means of displaying a picture, poem or message at a grave or memorial site. Some are made with movable members that will house the picture, poem, or other message between them leaving it susceptible to condensation build up that may fog the inside viewable section of the display. Other prior art depict displays that require assembly or additional materials to erect or to place them. No other prior art found shows a memorial display or marker that can be mailed using standard (first class) postage.

### BRIEF SUMMARY OF THE INVENTION

A one piece display that can be anchored into the soil due to a bottom tapered end. Made of a durable material of proper thickness that it will be rigid enough to hold its shape as it's pushed into the ground. A one piece display with dimensions and weight that will allow it to be mailed using a standard postage stamp when inserted into a card and/or envelope. A thin water proof display that can be written on by the user or sender to express their feelings and sentiments. A one piece display that can be sent by a person to another to display for them when distance prohibits them from displaying it themselves.

### BRIEF DESCRIPTION OF THE SEVERAL VIEWS OF THE DRAWING

FIG. 1 One piece display. Front or rear view.

FIG. 2 One piece display. Side view.

FIG. 3 Display that has been pushed into the ground.

FIG. 4 Parts and steps of a method to manufacture the display.

### DETAILED DESCRIPTION OF THE INVENTION

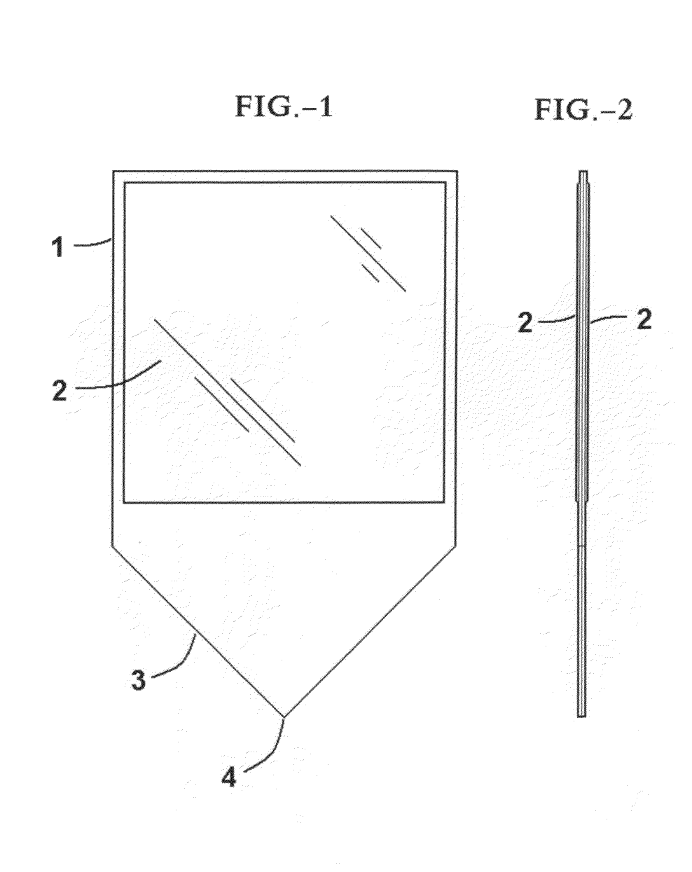

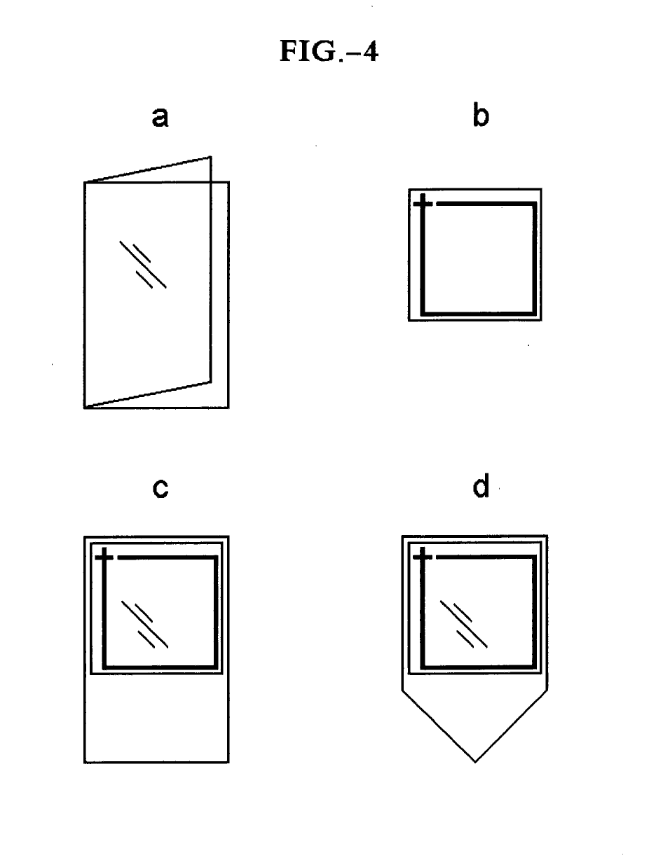

Essentially the display, FIG. 1, is any predetermined printed or unprinted flat material, FIG. 4-b, that has been laminated in plastic (2) with the bottom end corners cut at an angle (3) producing a pointed or semi pointed bottom end (4).

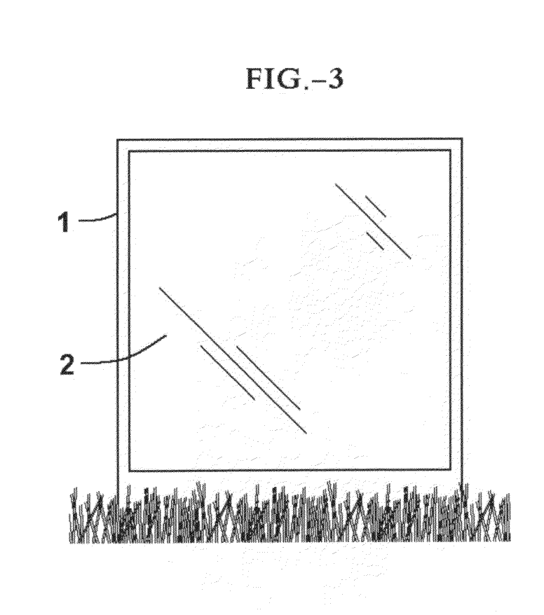

Clear lamination (1) of the printed/unprinted material will produce a two sided flat display, FIG. 2. Lamination (@24 mills for example) will produce a thin display that will have enough rigidity so it will be able to be pushed or rocked into the ground, FIG. 3. Lamination of the printed or unprinted material will produce a water tight display that will prohibit condensation on the inside to form causing the display to appear cloudy.

One method of manufacturing the display is to use a clear laminating pouch, FIG. 4-a, and placing the printed or unprinted material FIG. 4-b in the top portion of the pouch leaving an edge around the material so the laminate will seal around all edges of the material, FIG. 4-c, making it water tight. Once sealed, the bottom corners of the Pouch (bottom area that has no material in it) are cut at an angle to produce a point or semi pointed end leaving the material inside sealed around all edges, FIG. 4-d.

To use hold the display by the top edge and place the bottom edge point at the desired location. Push down on display to drive pointed edge into the ground to a depth that can support the display in place. If the ground or dirt is to firm to push the display down to a suitable depth, the user can rock it back and forth with a cutting motion as they push down on the display.

The user has the option to add a personnel message to the display using a permanent marker before displaying it or mailing it to a person to display it for them.

1. A one piece water proof memorial marker incorporating a tapered bottom edge that will facilitate implantation into the ground or earth.

2. A one piece memorial marker of a thickness that will be thin enough to fit in a memorial/sympathy card and/or envelope and mailed using standard letter postage.

3. A one piece memorial marker of a thickness that will maintain enough rigidity to be pushed or rocked into the ground or earth.
